(19) United States
(12) Patent Application Publication
(10) Pub. No.: US 2024/0023156 A1
(43) Pub. Date: Jan. 18, 2024

(54) SYSTEMS AND METHODS FOR SIDELINK SENSING WITH BEAMFORMING

(71) Applicant: QUALCOMM Incorporated, San Diego, CA (US)

(72) Inventors: Jung Ho Ryu, Fort Lee, NJ (US); Sony Akkarakaran, Poway, CA (US); Tao Luo, San Diego, CA (US); Junyi Li, Fairless Hills, PA (US); Hua Wang, Basking Ridge, NJ (US); Gabi Sarkis, San Diego, CA (US); Tien Viet Nguyen, Bridgewater, NJ (US); Juan Montojo, San Diego, CA (US)

(21) Appl. No.: 17/865,055

(22) Filed: Jul. 14, 2022

(51) Int. Cl. H04W 72/10; H04W 74/08; H04W 72/04

(52) U.S. Cl. CPC H04W 72/10; H04W 74/0808; H04W 72/0406

(57) ABSTRACT

Disclosed is a method for wireless communication. The method comprises: determining a first set of slots within a sidelink resource pool, determining a set of candidate single-slot resources, each candidate single-slot resource associated with a slot of the first set of slots, determining a second set of slots within the sidelink resource pool based on the first set of slots, wherein the first set of slots and the second set of slots do not overlap, monitoring for one or more transmissions comprising control information in each slot of the second set of slots, wherein the monitoring comprises using a receive beam, selectively excluding, based on the control information, one or more resources from the set of candidate single-slot resources, and transmitting a sidelink transmission in one or more remaining resources of the set of candidate single-slot resources.

### INTRODUCTION

Aspects of the present disclosure generally relate to wireless communications, and more particularly to techniques and apparatuses for sidelink communications.

Wireless communication systems are widely deployed to provide various telecommunication services such as telephony, video, data, messaging, and broadcasting. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems.

A wireless communication network may include a number of base stations (BSs) that can support communication for a number of user equipments (UEs). A user equipment (UE) may communicate with a base station (BS) via downlink and uplink. The downlink (or forward link) refers to a communication link from the BS to the UE, and the uplink (or reverse link) refers to a communication link from the UE to the BS. As will be described in more detail herein, a BS may also be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. LTE/LTE-Advanced is a set of enhancements to the Universal Mobile Telecommunications System (UMTS) mobile standard promulgated by the Third Generation Partnership Project (3GPP). New Radio (NR), which may also be referred to as 5G, is a set of enhancements to the LTE mobile standard promulgated by the Third Generation Partnership Project (3GPP). NR is designed to by better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

However, as the demand for mobile broadband access continues to increase, there exists a need for further improvements in wireless communications. Preferably, these improvements should be applicable to LTE and/or NR, and/or also to other multiple access technologies and the telecommunication standards that employ these technologies.

### SUMMARY

In some aspects of the present disclosure, a method for wireless communication is disclosed, the method being performed by a user equipment (UE), may include determining a first set of slots within a sidelink resource pool, determining a set of candidate single-slot resources, each candidate single-slot resource associated with a slot of the first set of slots, determining a second set of slots within the sidelink resource pool based on the first set of slots, wherein the first set of slots and the second set of slots do not overlap, monitoring for one or more transmissions comprising control information in each slot of the second set of slots, wherein the monitoring comprises using a receive beam, selectively excluding, based on the control information, one or more resources from the set of candidate single-slot resources, and transmitting a sidelink transmission in one or more remaining resources of the set of candidate single-slot resources.

In some aspects of the present disclosure, an apparatus for wireless communication may include means for determining a first set of slots within a sidelink resource pool, means for determining a set of candidate single-slot resources, each candidate single-slot resource associated with a slot of the first set of slots, means for determining a second set of slots within the sidelink resource pool based on the first set of slots, wherein the first set of slots and the second set of slots do not overlap, means for monitoring for one or more transmissions comprising control information in each slot of the second set of slots, wherein the monitoring comprises using a receive beam, means for selectively excluding, based on the control information, one or more resources from the set of candidate single-slot resources, and means for transmitting a sidelink transmission in one or more remaining resources of the set of candidate single-slot resources.

In some aspects of the present disclosure, an apparatus for wireless communication may include a memory and one or more processors coupled to the memory, the memory and the one or more processors may be configured to determine a first set of slots within a sidelink resource pool, determine a set of candidate single-slot resources, each candidate single-slot resource associated with a slot of the first set of slots, determine a second set of slots within the sidelink resource pool based on the first set of slots, wherein the first set of slots and the second set of slots do not overlap, monitor for one or more transmissions comprising control information in each slot of the second set of slots, wherein the monitoring comprises using a receive beam, selectively exclude, based on the control information, one or more resources from the set of candidate single-slot resources, and transmit a sidelink transmission in one or more remaining resources of the set of candidate single-slot resources.

In some aspects of the present disclosure, a non-transitory computer-readable medium may store one or more instructions for wireless communication. The one or more instructions, when executed by one or more processors, for instance one or more processors of a UE, may cause the one or more processors to determine a first set of slots within a sidelink resource pool, determine a set of candidate single-slot resources, each candidate single-slot resource associated with a slot of the first set of slots, determine a second set of slots within the sidelink resource pool based on the first set of slots, wherein the first set of slots and the second set of slots do not overlap, monitor for one or more transmissions comprising control information in each slot of the second set of slots, wherein the monitoring comprises using a receive beam, selectively exclude, based on the control information, one or more resources from the set of candidate single-slot resources, and transmit a sidelink transmission in one or more remaining resources of the set of candidate single-slot resources.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited aspects of the present disclosure can be understood in detail, a more particular description, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIG. 3 is a block diagram conceptually illustrating an example of a frame structure in a wireless communication network, in accordance with various aspects of the present disclosure

FIG. 4 is a diagram illustrating full sensing in accordance with various aspects of the present disclosure.

FIG. 5 is a diagram illustrating resource reservation for sidelink transmissions of multiple transport blocks (TBs) in accordance with various aspects of the present disclosure.

FIG. 6 is a diagram illustrating periodic-based partial sensing (PBPS) in accordance with various aspects of the present disclosure.

FIG. 7 is a diagram illustrating contiguous partial sensing (CPS) in accordance with various aspects of the present disclosure.

FIG. 8A illustrates an exemplary process flow for creating an aperiodic mode 2 sidelink (SL) transmission grant according to aspects of the present disclosure.

FIG. 8B illustrates an exemplary process flow for creating a periodic mode 2 SL transmission grant according to aspects of the present disclosure.

FIGS. 9A and 9B are block diagrams conceptually illustrating examples of sidelink transmissions using beamforming, in accordance with various aspects of the present disclosure.

FIGS. 9C and 9D are block diagrams conceptually illustrating an example of resources available for a sidelink transmissions, in accordance with various aspects of the present disclosure.

FIG. 10 is a diagram illustrating an example process performed, for example, by a UE, in accordance with various aspects of the present disclosure.

### DETAILED DESCRIPTION

Various aspects of the present disclosure are described in more detail hereinafter with reference to the accompanying drawings. This disclosure may, however, be implemented in many different forms and should not be construed as limited to any specific structure or function presented throughout this disclosure. Rather, these aspects are provided so that this disclosure will be thorough and complete, and will fully convey the scope of the present disclosure to those skilled in the art. Based on the teachings herein one skilled in the art should appreciate that the scope of the present disclosure is intended to cover any aspect of the present disclosure disclosed herein, whether implemented independently of or combined with any other aspect of the present disclosure. For example, an apparatus may be implemented or a method may be practiced using any number of the aspects set forth herein. In addition, the scope of the present disclosure is intended to cover such an apparatus or method which is practiced using other structure, functionality, or structure and functionality in addition to or other than the various aspects of the present disclosure set forth herein. It should be understood that any aspect of the present disclosure disclosed herein may be implemented by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies and Open RAN (O-RAN) technologies.

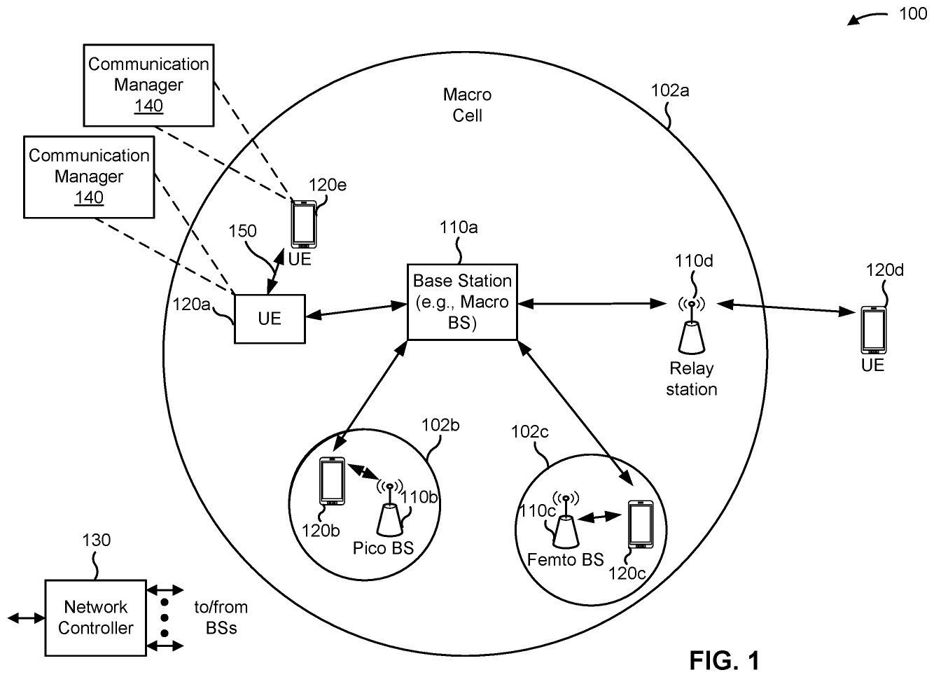

FIG. 1 is a diagram illustrating a wireless network 100 in which aspects of the present disclosure may be practiced. The wireless network 100 may be an LTE network, a 5G or NR network, and/or the like. Wireless network 100 may include a number of BSs 110 (shown as BS 110a, BS 10b, BS 10c, and BS 10d) and other network entities. A BS is an entity that communicates with user equipments (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 10a may be a macro BS for a macro cell 102a, a BS 10b may be a pico BS for a pico cell 102b, and a BS 10c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station BS 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to one or more (e.g., a set of) BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c, 120d, 120e, and/or the like) may be dispersed throughout wireless network 100, and each UE may be stationary or mobile. A UE may communicate with one or more BSs in wireless network 100, may communicate directly with another UE (e.g., UE 120a and UE 120e, as illustrated in FIG. 1) via a sidelink (e.g., link 150 shown in FIG. 1 as connecting UE 120a and UE 120e), and/or the like.

In some cases, two or more subordinate entities (e.g., UEs) may communicate with each other using sidelink signals. Real-world applications of such sidelink communications may include public safety, proximity services, UE-to-network relaying, vehicle-to-everything (V2X) communications, Internet of Everything (IoE) communications, Internet-of-Things (IoT) communications, mission-critical mesh, and/or various other suitable applications. Generally, a sidelink signal may refer to a signal communicated from one subordinate entity (e.g., UE1) to another subordinate entity (e.g., UE2) without relaying that communication through a scheduling entity (e.g., UE or BS), even though the scheduling entity may be utilized for scheduling and/or control purposes. In some examples, the sidelink signals may be communicated using a licensed spectrum (unlike wireless local area networks, which may use an unlicensed spectrum).

A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered as machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node (e.g., UE, BS, or the like) may provide, for example, connectivity for or to a network (e.g., a wide area network such as Internet or a cellular network) via a wired or wireless communication link. Some UEs may be considered as Internet-of-Things (IoT) devices, and/or may be implemented as NB-IoT (narrowband internet of things) devices. Some UEs may be considered as a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

As described herein, a wireless node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad, open-ended way. The example above where a UE is configured to receive information from a base station also discloses that a first network node is configured to receive information from a second network node, where the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, when the first network node is configured to transmit information to the second network node, the first network node may be configured to provide, send, output, communicate, or transmit information to the second network node. Similarly, in this example and consistent with this disclosure, when the first network node is configured to transmit information to the second network node, the second network node may be configured to receive, obtain, or decode the information that is provided, sent, output, communicated, or transmitted by the first network node.

As shown in FIG. 1, the UE 120 may include a communication manager 140. As described in more detail elsewhere herein, the communication manager 140 may receive a sidelink communication on a sidelink (e.g., link 150) between the UE 120 (e.g., UE 120a) and another UE 120 (e.g., UE 120e), may transmit, on the sidelink, one or more feedback communications associated with the sidelink communication in a reporting period having a configurable periodicity, and/or the like. As described in more detail elsewhere herein, the communication manager 140 may receive a sidelink communication on a sidelink between the UE 120 and another UE 120, may transmit, on the sidelink, one or more feedback communications associated with the sidelink communication in a reporting period configured to occupy an entire bandwidth of a resource pool configured for the sidelink, and/or the like. As described in more detail elsewhere herein, the communication manager 140 may transmit a sidelink communication on a sidelink between the UE 120 and another UE 120, may receive, on the sidelink, one or more feedback communications associated with the sidelink communication in a reporting period having a configurable periodicity, and/or the like. As described in more detail elsewhere herein, the communication manager 140 may transmit a sidelink communication on a sidelink between the UE 120 and another UE 120, may receive, on the sidelink, one or more feedback communications associated with the sidelink communication in a reporting period configured to occupy an entire bandwidth of a resource pool configured for the sidelink, and/or the like. Additionally, or alternatively, the communication manager 140 may perform one or more other operations described herein.

As indicated above, FIG. 1 is provided merely as an example. Other examples may differ from what is described with regard to FIG. 1.

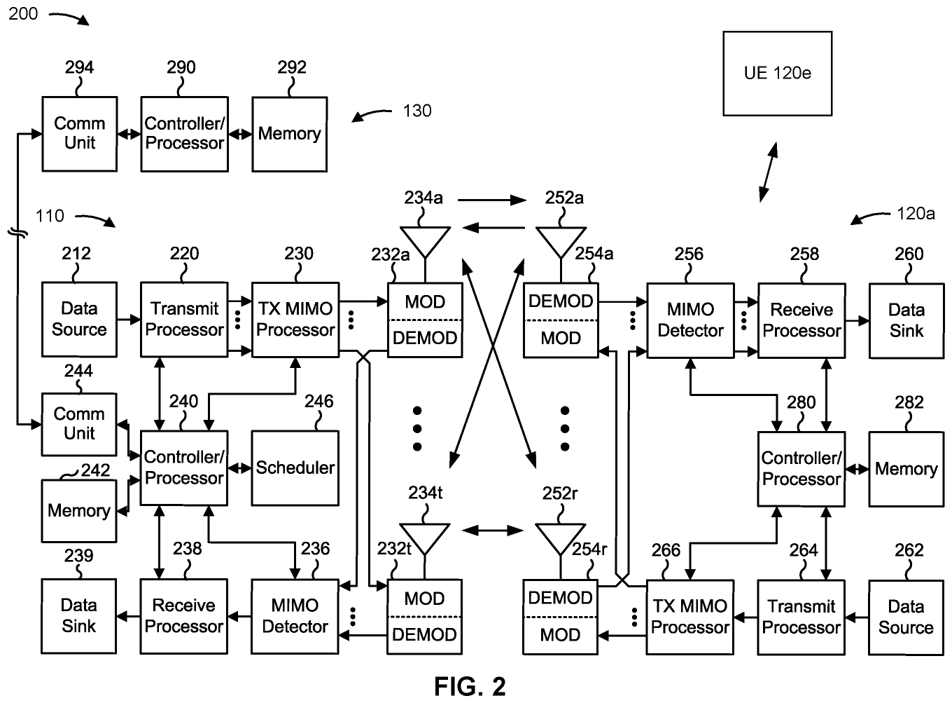

FIG. 2 shows a block diagram of a design 200 of base station 110, UE 120a and UE 120e, which may be one of the base stations and one of the UEs in FIG. 1. UE 120e may be equipped analogously to UE 120a. Base station 110 may be equipped with T antennas 234a through 234t, and UE 120a may be equipped with R antennas 252a through 252r, where in general T 1 and R 1.

At base station 110, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (Tx) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 (e.g., 232a through 232t) may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120a, antennas 252a through 252r may receive the downlink signals from base station 110 and/or other base stations, may receive sidelink signals from another UE 120e (e.g., UE 120a may receive sidelink signals from UE 120e and/or vice-versa) and may provide received signals to demodulators (DEMODs) 254a through 254r, respectively. Each demodulator 254 (e.g., 254a through 254r) may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120a to a data sink 260, and provide decoded control information and system information to a controller/processor 280. A channel processor may identify reference signal received power (RSRP), received signal strength indicator (RSSI), reference signal received quality (RSRQ), channel quality indicator (CQI), and/or the like. In some aspects, one or more components of UE 120a and/or UE 120e may be included in a housing.

On the uplink or a sidelink, at UE 120a, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a Tx MIMO processor 266 if applicable, further processed by modulators 254a through 254r (e.g., for DFT-s-OFDM, CP-OFDM, and/or the like), and transmitted to base station 110 on the uplink and/or to another UE 120e on the sidelink. At base station 110, the uplink signals from UE 120a, UE 120e, and other UEs may be received by antennas 234 (e.g., 234a through 234t), processed by demodulators 232, detected by a MIMO detector 236 if applicable, and further processed by a receive processor 238 to obtain decoded data and control information sent by UE 120a and/or UE 120e. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

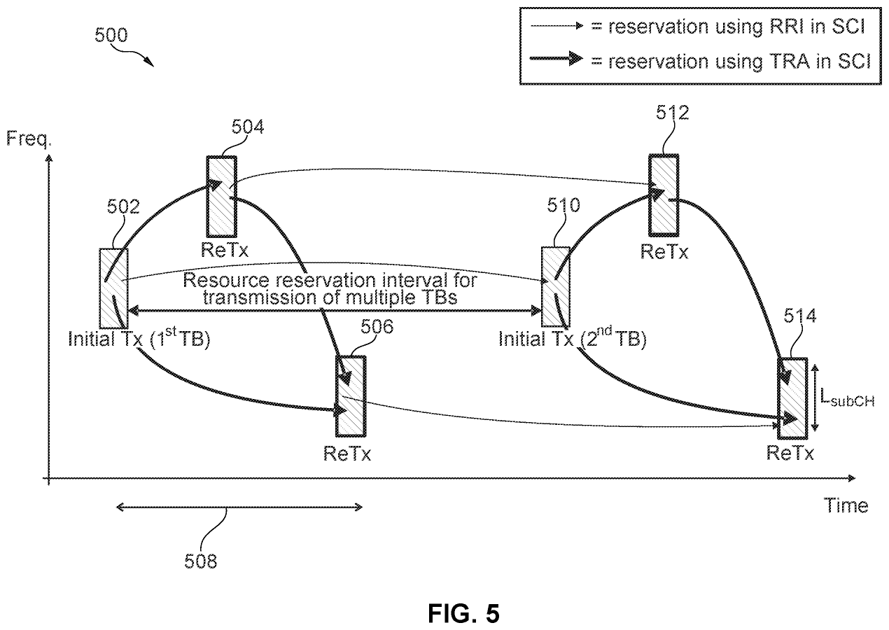

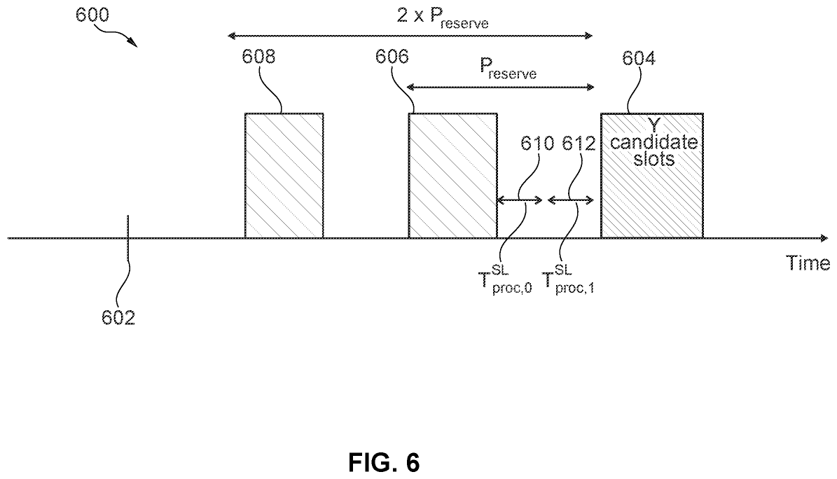

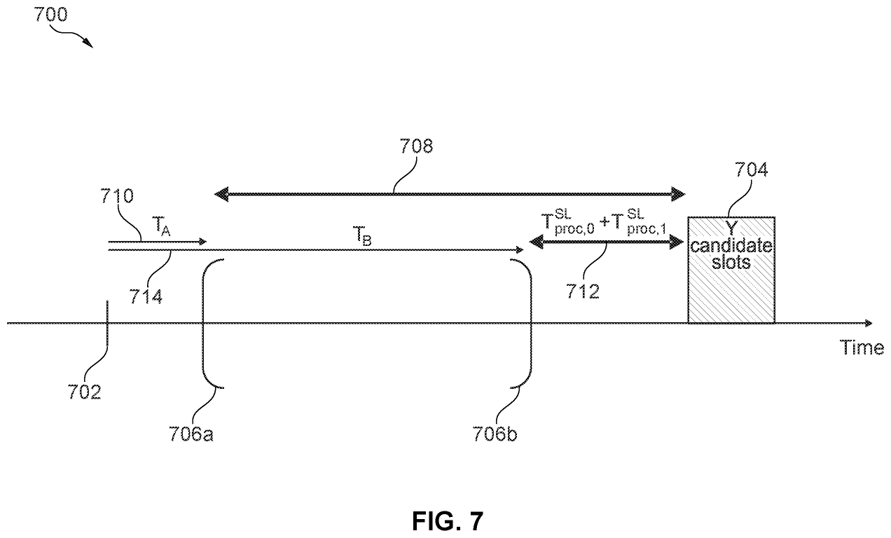

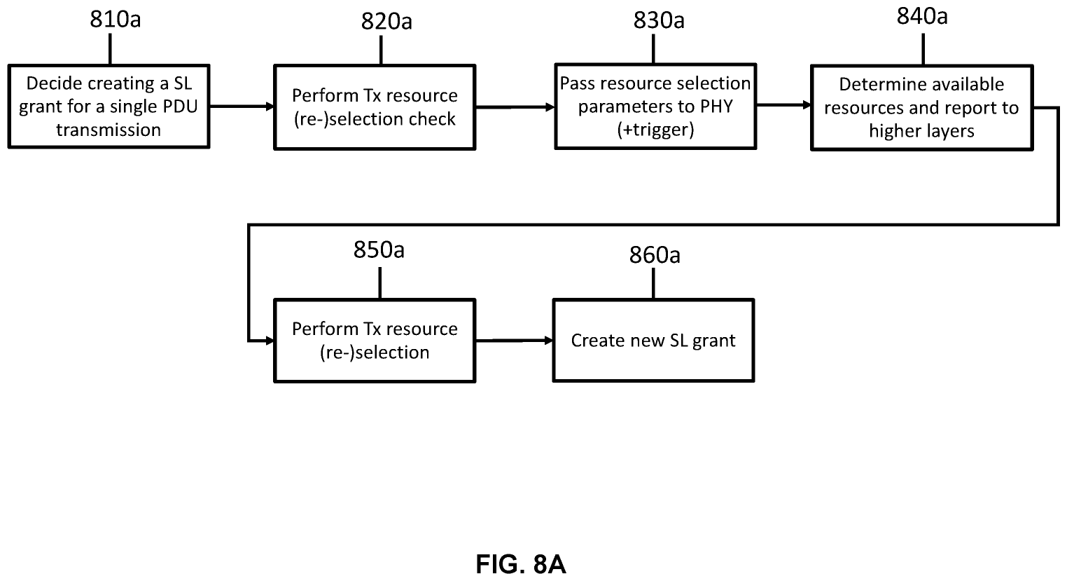

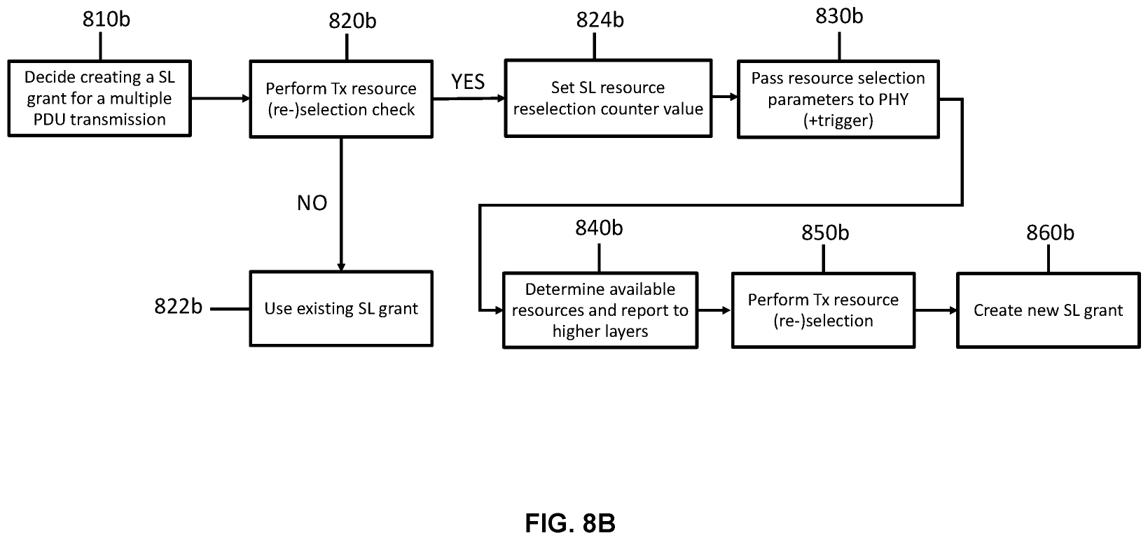

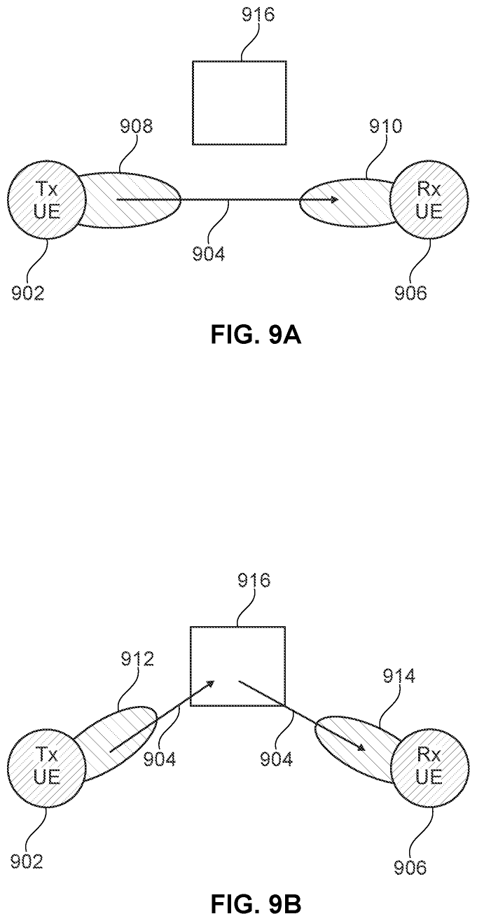

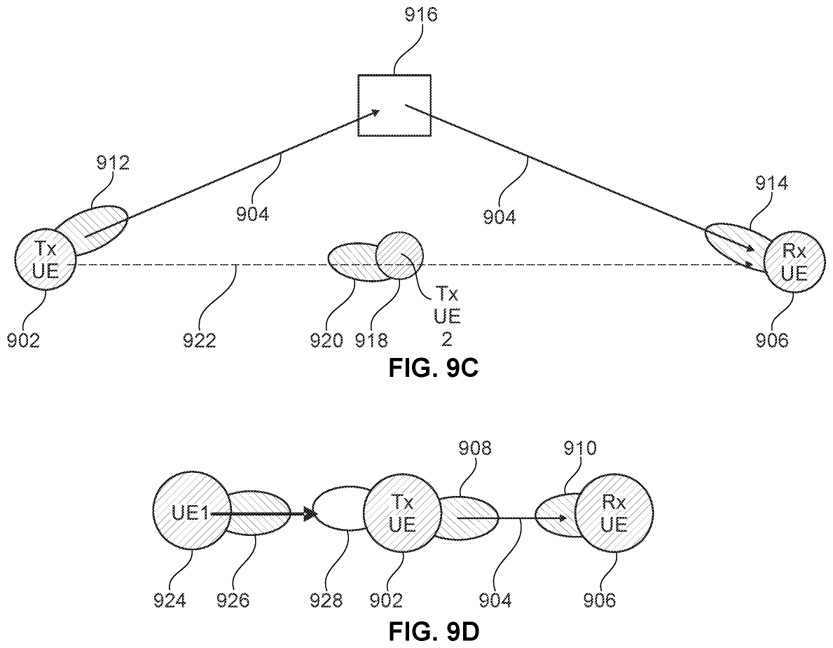

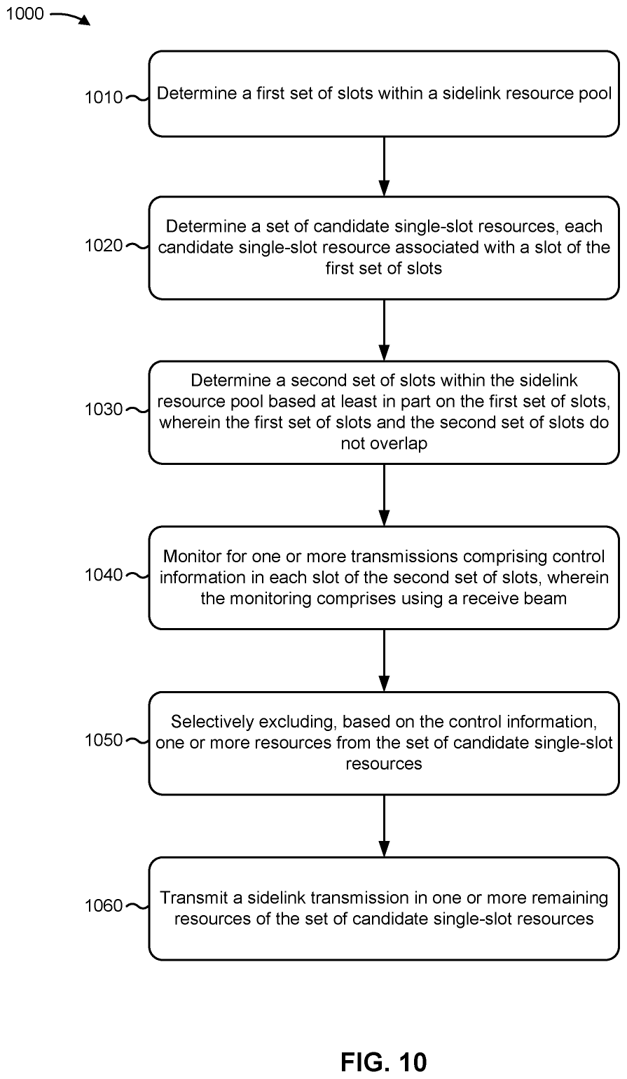

Controller/processor 240 of base station 110, controller/processor 280 of UE 120a, and/or any other component(s) of FIG. 2 may perform one or more techniques associated with feedback for sidelink communications, as described in more detail elsewhere herein. For example, controller/processor 240 of base station 110, controller/processor 280 of UE 120a, and/or any other component(s) of FIG. 2 may perform or direct operations of, for example, methods of FIG. 5, FIG. 6, FIG. 7, or FIG. 9, or processes of FIG. 8 or FIG. 10, and/or other methods and processes as described herein. Memories 242 and 282 may store data and program codes for base station 110 and UE 120a, respectively. A scheduler 246 may schedule UEs for data transmission on the downlink and/or uplink.

In some aspects, a UE 120 (e.g., UE 120a and/or UE 120e) may include means for determining a first set of slots within a sidelink resource pool, means for determining a set of candidate single-slot resources, each candidate single-slot resource associated with a slot of the first set of slots, means for determining a second set of slots within the sidelink resource pool based on the first set of slots, wherein the first set of slots and the second set of slots do not overlap, means for monitoring for one or more transmissions comprising control information in each slot of the second set of slots, wherein the monitoring comprises using a receive beam, means for selectively excluding, based on the control information, one or more resources from the set of candidate single-slot resources, and/or means for transmitting a sidelink transmission in one or more remaining resources of the set of candidate single-slot resources.

As indicated above, FIG. 2 is provided merely as an example. Other examples may differ from what is described with regard to FIG. 2.

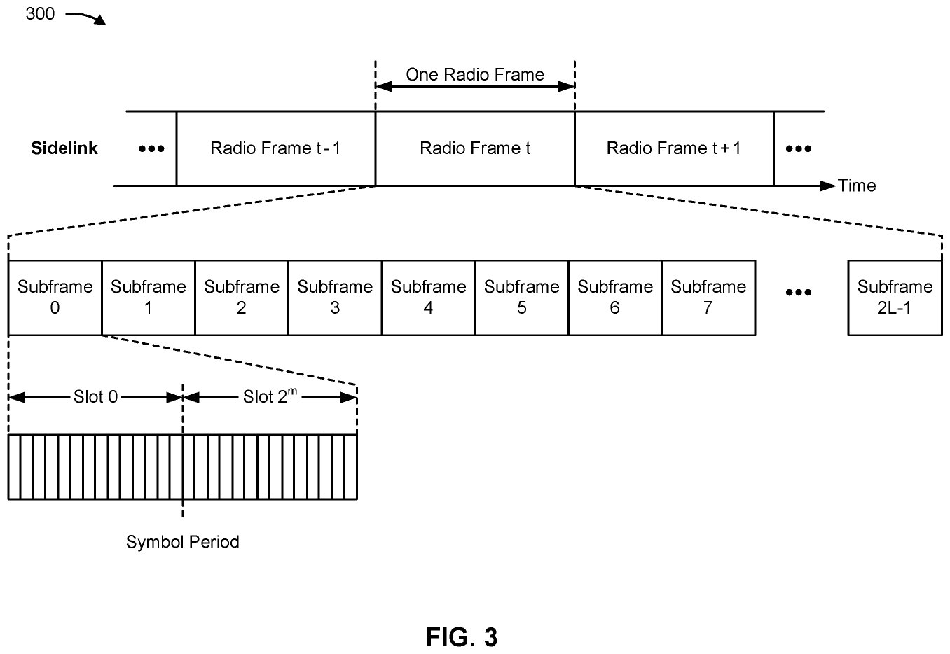

FIG. 3 shows an example frame structure 300 for frequency division duplexing (FDD), on a sidelink between UEs, in a telecommunications system (e.g., LTE, 5G NR, and/or the like). The transmission timeline for the sidelink may be partitioned into units of radio frames, where t represents time. Each radio frame may have a predetermined duration (e.g., 10 milliseconds (ms)) and may be partitioned into a plurality of subframes with indices of 0 through 2L−1. Each subframe may include two slots. As an example, each radio frame may be partitioned into 10 subframes 0 through 9 and 20 slots with indices of 0 through 19. Each slot may include a plurality of symbol periods, such as seven symbol periods for a normal cyclic prefix or six symbol periods for an extended cyclic prefix.

In some aspects, a UE (e.g., UE 120a, UE 120e, and/or the like) may transmit, to another UE (e.g., UE 120a, UE 120e, and/or the like) on a sidelink, one or more sidelink communications in a transmission period, which may include one or more slots included in frame structure 300. In some aspects, the other UE may receive the one or more sidelink communications, may generate feedback for the one or more sidelink communications, may incorporate the feedback into one or more feedback communications, and may transmit, to the UE on the sidelink, the one or more feedback communications in one or more symbols and/or slots included in a reporting period, in frame structure 300, configured for the sidelink.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol.

As indicated above, FIG. 3 is provided merely as an example. Other examples may differ from what is described with regard to FIG. 3.

In some aspects of the present disclosure, multiple deployment scenarios for sidelink communication in terms of a relationship between the sidelink communication and an overlaid cellular network may exist. In one aspect, devices (e.g., wireless devices, UEs) involved in sidelink communications may be under a coverage of an overlaid cellular network (e.g., a NR network). The overlaid cellular network may control sidelink communications, for instance, the overlaid network may schedule the sidelink transmissions. In some aspects, in-coverage operation may sometimes use (or be referred to as) a resource-allocation mode 1 (e.g., a NR mode 1 SL). In case of the in-coverage operation, sidelink communications may share carrier frequency with the overlaid cellular network. Alternatively, sidelink communications may take place on a sidelink-specific carrier frequency different from carrier frequency (or carrier frequencies) of the overlaid cellular network. In another aspect, the devices involved in the sidelink communications may not be within the coverage of an overlaid cellular network. In some aspects, out-of-coverage operation may sometimes use (or be referred to as) a resource-allocation mode 2 (e.g., a NR mode 2 SL). In out-of-coverage operation, decision on sidelink transmission may be determined by a device (e.g., a transmitting device, a Tx UE) itself based, for instance, on sensing and resource selection procedure. Such decision may include determining a set of resources for use in the sidelink transmission.

In some aspects of the present disclosure, sidelink transmission (e.g., NR sidelink transmission) may be based on a multiplexing technique such as OFDM. A device which is configured for sidelink transmission may be configured (e.g., pre-configured, statically or dynamically configured by the network) with a sidelink resource pool. A sidelink resource pool may define, among others, overall time/frequency resources that may be used for sidelink communication within a carrier. In a time domain, a resource pool may comprise a set of slots repeated over a resource pool period (e.g., a resource pool period associated with a resources pool such as in NR). Thus, in the time domain, a resource pool may be defined by specifying, among others, a configurable resource-pool period, a configurable set of sidelink slots within the resource-pool period, and/or the like. Expressed differently, in some aspects, a resource-pool may have a slot-based granularity in the time domain. In a frequency domain, the resource pool may comprise a set of consecutive subchannels, where a subchannel may be composed of a number of resource blocks (e.g., a number of consecutive resource blocks, for instance, 10, 15, 20, 25, 50, 75 or 100 consecutive resource blocks) and/or a configurable resource-pool bandwidth corresponding to a set of consecutive subchannels. In some aspects, the resource pool may be defined by additionally specifying a frequency-domain location of a subchannel of the resource pool.

In some aspects of the present disclosure, a transmitting device (e.g., a Tx UE) may facilitate a sensing and resource-selection procedure by providing one or more resources-reservation announcements. A resource reservation announcement may provide information (for instance, to other devices) about which set of resources a device (e.g., nearby Tx UE) has selected for future sidelink transmissions. For instance, in some aspects of the present disclosure, a device may reserve resources, for instance, for up to two additional transmissions within a time window corresponding to a number of slots including a current slot (e.g., 32 slots including the current slot). Each of these future transmissions may have the same bandwidth as the transmission in the current slot but may have different frequency-domain locations. Information about such reserved resources may be provided in terms of time offsets (for instance, Δt1 and Δt2) and/or frequency shifts (for instance, Δf1 and Δf2) and may be provided as part a resource reservation within control information (e.g., sidelink control information—SCI, more specifically, 1st stage SCI in NR). In addition, or alternatively, a device may reserve periodically occurring sets of resources for a sidelink transmission. Each of such periodically occurring set of resources may have the same structure (bandwidth, frequency shifts, and/or relative time offsets) as an initial transmission and may periodically occur with a period Tp. In some aspects, the period Tp may range from 1 ms up to 900 ms. In some aspects, a set of allowed periods Tp may be configured by higher layers (e.g., via RRC signaling such as sl-ResourceReservePeriodList message in NR). In some aspects of the present disclosure, control information (e.g., SCI) may comprise one or more of a time resource assignment (TRA) field, a frequency resource assignment (FRA) field, or a resource reservation interval (RRI) field.

In accordance with one or more aspects of the present disclosure, a device (e.g., a UE 120a, 120e, for instance, a Tx UE) may perform a sensing and resource (e.g., one or more time resources and/or one or more frequency resources) selection procedure by which the device may select a set of resources to use for sidelink transmission based on resource reservations (e.g., in control information, for instance, TRA/FRA/RRI fields in SCI) announced by other devices. A sidelink transmission may be assigned a delay budget implying that this sidelink transmission is expected to be transmitted within a certain time window. Alternatively, or in addition, the sidelink transmission may be assigned a priority.

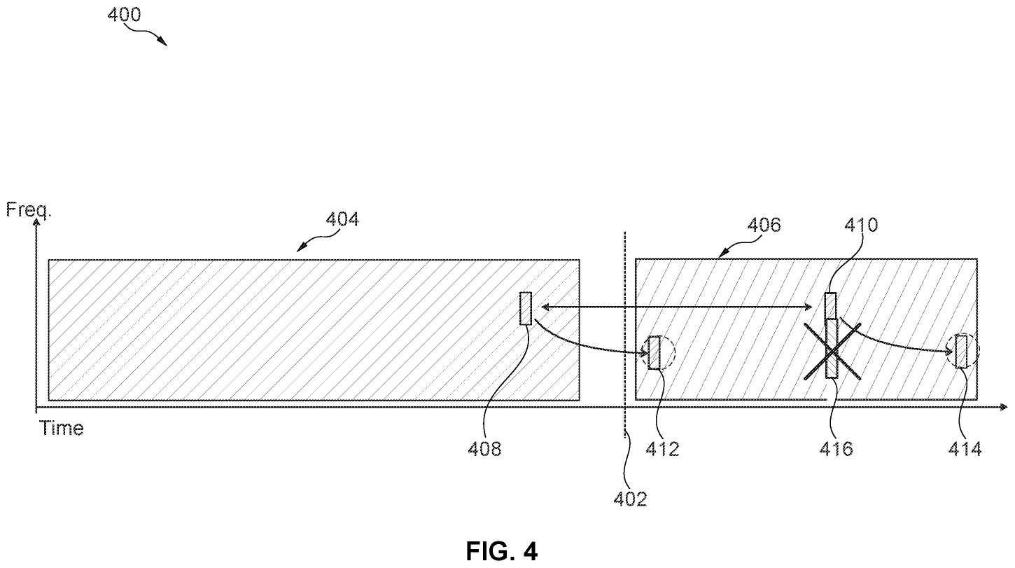

According to an aspect of the present disclosure, a device (e.g., a UE 120a, 120e, a Tx UE or the like) may perform full sensing. FIG. 4 is a diagram illustrating full sensing 400 in accordance with various aspects of the present disclosure. The device may, for example, generate (or obtain) a resource selection trigger in a slot 402 (e.g., SL slot n) such that the device may decide to perform a sidelink transmission and may need to determine resources available for such transmission. The determining may be based on channel sensing. More specifically, the UE may be sensing (e.g., monitoring) the channel substantially all the time (e.g., in the entire sensing window 404), for example, substantially longer than 900 ms. The device may intend to identify available resources for the sidelink transmission in a resource selection window 406. The device may be sensing/monitoring for SCIs from nearby transmitting UEs comprising information (one or more resources-reservation announcements) about resources that a nearby transmitting UE will be using for future sidelink transmissions.

For instance, as shown in FIG. 4, UE1 (e.g., the UE 120a, 120e, a Tx UE or the like) may receive, in slot m, SCI1 408 from UE2. The device may determine that SCI1 408 indicates a resource reservation interval (RRIᵢ) and a priority pᵢ. Further, the device may determine that reference signal received power (RSRP) is higher than a threshold associated with a pair of priorities pᵢ, pⱼ, for instance, a threshold Th(pᵢ, pⱼ). The priority pⱼ may be associated with a sidelink transmission the device intends to transmit. Expressed differently, determination of resources available for the sidelink transmission may also be based on RSRP of the received SCIs, a priority pⱼ of the sidelink transmission by the device (e.g., Tx UE's transmission), and a priority pᵢ in the received SCIs. Continuing with FIG. 4, the SCI1 may comprise RRIᵢ≠0 indicating a future (e.g., periodic) sidelink transmission in a resource 410. In addition, or alternatively, SCI1 may comprise TRA/FRA indicating a future sidelink transmission in a resource 412. In a similar manner, a sidelink transmission in the resource 410 may indicate (e.g., by using TRA/FRA) a future sidelink transmission in a resource 414.

Upon obtaining the trigger in the slot 402, the device may, based on received reservations transmitted by nearby devices, determine which resources are available for its own sidelink transmission. A candidate resource (e.g., candidate single-slot resource, such as R_{x,y} in NR) may be defined as a set of a number (e.g., L_{subCH} in NR) contiguous sub-channels (e.g., with a sub-channel x+j in a slot t_{y} in a sidelink resource pool, where j=0, . . . , L_{subCH}−1). In some aspects, the number L_{subCH} may refer to a number of sub-channels to be used for a sidelink transmission in a slot and may be configured by higher layers (e.g., via RRC signaling). The device may, from a set of candidate resources (e.g., candidate single-slot resources) within the resource selection window 406, determine to selectively exclude resource 416 (e.g., contiguous L_{subCH} resources, such as resource R_{x,y} in NR) in view of an overlap with the reserved resource 410. In a similar manner, the device may determine to exclude any candidate resource (not shown) from the set of candidate resources in view of an overlap with any resource reserved by any nearby UEs (determined by the device by sensing/monitoring for transmissions/reservations by nearby UEs).

A physical (PHY) layer of the device may then provide a set of available resources that the device may use to select one or more resources for the sidelink transmission (i.e., the set of remaining candidate resources, which may be sometimes referred to as S_{A}) to a medium access control (MAC) layer. Thereupon, the MAC layer may select one or more resources to be used by the sidelink transmission and effectuate the sidelink transmission in the selected one or more resources by the PHY layer (not shown in FIG. 4).

In accordance with an aspect of the present disclosure, a device may intend to transmit multiple transport blocks (TBs). FIG. 5 is a diagram illustrating resource reservation for sidelink transmissions of multiple TBs 500 in accordance with various aspects of the present disclosure. In an aspect, the device may transmit an initial transmission of a first TB in a time/frequency resource 502. Using TRA/FRA in SCI, the device may reserve a number of resources (e.g., up to 2 resources, such as R_{x,y} in NR) for future transmissions. In FIG. 5, the initial transmission (e.g., initial Tx) of the first TB in the resource 502 reserves a resource 504 and a resource 506, for instance, for repetitions (e.g., ReTx) of the initial transmission. The resource 504 may involve a minimum time gap relative to the resource 502. Similarly, the resource 506 may involve a minimum time gap relative to the resource 504. In addition, the resources for a transmission (e.g., 502) and corresponding retransmissions (e.g., 504 and 506) may be up to a number of slots (e.g., 31 slots) apart. In one or more aspects of the present disclosure, the resources 502, 504 and 506 may be collectively referred to as one period 508. One period may comprise the initial transmission and subsequent retransmissions of the initial transmission.

In addition, RRI in SCI of a sidelink transmission may reserve a set of periodic resources for sidelink transmissions of multiple TBs. For instance, the initial transmission of the first TB in the resource 502 may reserve, by using RRI in its SCI, a periodic resource, such as a resource 510 (shown in FIG. 5) or subsequent periodic resources (not shown). The periodic resources (e.g., the resource 510) may be used for transmitting subsequent TBs of the multiple TBs following the first TB. For instance, an initial transmission (e.g., initial Tx) of a second TB may be transmitted in the resource 510. Similarly, the retransmission of the first TB in the resource 504 may reserve, by using RRI in its SCI, a periodic resource, such as a resource 512 (shown in FIG. 5) or subsequent periodic resource (not shown). The periodic resource (e.g., the resource 512) may be used for transmitting retransmissions of the subsequent TBs. Similarly, RRI in SCI of the retransmission in the resource 506 may reserve a periodic resource comprising a resource 514 (shown in FIG. 5) or subsequent resources (not shown). In one or more aspects, the periodicity indicated in RRI may be selected from a set of allowed periods. For example, the set of allowed periods may be configured by higher layers (e.g., via RRC signaling such as sl-ResourceReservePeriodList message in NR). In other aspects, alternatively or in addition to the above, RRI of the sidelink transmission in the resource 510 may reserve the resources 512 and 514 by using respective TRA/FRA.

In one or more aspects of the present disclosure, partial sensing may be used to reduce power consumption of a device (e.g., a UE 120a, 120e, a Tx UE or the like) in contrast to the aforementioned full sensing. To avoid sensing the channel all the time (e.g., during the entire sensing window 404 shown in FIG. 4), the device may only sense (e.g., monitor) a fraction of time/frequency resources (e.g., of a channel). To reduce the sensing effort, the device may determine a set of candidate slots (e.g., the set Y of candidate slots) in which the device may intend to perform sidelink transmissions. Partial sensing may consider reservation (e.g., announcement) rules for sidelink transmissions (e.g., reservation rules using TRA/FRA and/or RRI in SCIs, as described in FIG. 5) and the set of candidate slots. In various aspects of the present disclosure, partial sensing may include periodic-based partial sensing (PBPS) or contiguous partial sensing (CPS). For instance, in accordance with one or more aspects of the present disclosure, PBPS may be used to determine one or more resources that are reserved by nearby devices (e.g., Tx UEs) performing periodic transmissions (e.g., sidelink transmissions) by their own. Such determining may be based on RRIs in SCI of the sensed (e.g., monitored, and/or received) sidelink transmissions (including initial transmissions and retransmissions). Further, for instance, in accordance with one or more aspects of the present disclosure, CPS may be used to determine one or more resources that are reserved by nearby devices (e.g., Tx UEs) for retransmission. Such determining may be based on one or more TRAs/FRAs in SCI of the sensed (e.g., monitored, and/or received) sidelink transmissions (and/or retransmissions).

As described above, according to an aspect of the present disclosure, a device (e.g., a UE 120a, 120e, a Tx UE or the like) may perform periodic-based partial sensing (PBPS). FIG. 6 is a diagram illustrating PBPS 600 in accordance with various aspects of the present disclosure. The device may, for example, similar as in case of full sensing, generate (or obtain) a resource selection trigger 602 in a slot (e.g., SL slot n). Based on a delay budget, a priority, and/or the like, of a sidelink transmission to be transmitted, and/or based on other considerations, the device may determine a set of candidate slots 604 (e.g., Y candidate slots in NR) in which it intends to transmit the sidelink transmission. However, in PBPS, unlike in full sensing, the device does not perform sensing (e.g., monitoring) of the channel substantially all the time prior to the resource selection trigger 602. Rather, in PBPS, to determine which resources in the set 604 are reserved by nearby devices (e.g., UEs), the device may sense (e.g., monitor) the channel only on certain slots prior to the set 604 based on control information (e.g., comprising one or more of reservations, periodicities, TRA/FRA, RRI, and/or the like) indicated in sidelink transmission by other devices, for instance, as described in the context of FIG. 5.

In one aspect of the present disclosure, in PBPS, the device may perform sensing only in sensing occasions having a periodic relationship with slots comprised in the set 604. For instance, the device may perform sensing in a set of slots 606. The set of slots 606 may be composed of slots having a certain time offset to slots in the set of candidate slots 604. Such offset may be equal to a periodicity of sidelink transmissions (by nearby devices) which may be expected by the device, for example, based on various configurations. Such configurations may include a periodicity Pᵣₑₛₑᵣᵥₑ which may be indicated by nearby devices in one or more RRIs in SCIs. In some aspects of the present disclosure, the periodicity may only assume values from a set of allowed periodicities configured by higher layers (e.g., via RRC signaling such as sl-ResourceReservePeriodList message in NR). Thus, to determine resources in the candidate set 604 which are reserved by nearby devices, the device may need to only sense the channel in a number of slots (e.g., a set of slots having a relationship k×Pᵣₑₛₑᵣᵥₑ slots, with k being a positive integer) prior to each slot in the candidate set 604. The device may perform such sensing for each expected periodicity (e.g., each configured periodicity Pᵣₑₛₑᵣᵥₑ).

Referring to FIG. 6, in some aspects of the present disclosure, the device may by default only sense in one sensing occasion in the set of slots 606 (i.e., for k=1). In other aspects, the device may alternatively or additionally sense other sensing occasions, for example, in a set of slots 608 (i.e., for k=2) or in further slots (i.e., for k≥3, not shown). Similar as in case of full sensing, in PBPS, the device may determine to exclude one or more resources from the set of candidate slots 604 in view of an overlap with resource reserved by one or more transmissions in the sensing occasions, for example, in the set of slots 606 or in the set of slots 608. Also, similar as in case of full sensing, the remaining resources in the set of candidate resources (e.g., a set of available resources S_{A} in NR) may then be reported (e.g., by the PHY layer) to the MAC layer of the device. In view of processing time at the PHY layer, in some aspects, a time offset 610 (e.g., T_{proc,0}^{SL}) may exist between a last slot in the last sensing occasion (e.g., the occasion of slots 606 for k=1) prior to the set of candidate slots 604 and a time instant of reporting the candidate resources to the MAC layer. Similarly, in view of processing time at the MAC layer, in some aspects, a time offset 612 (e.g., T_{proc,1}^{SL}) may exist between a time instant of reporting the candidate resources to the MAC layer and a first slot in the set of candidate slots 604.

As described above, according to aspects of the present disclosure, a device (e.g., a UE 120a, 120e, a Tx UE or the like) may perform contiguous partial sensing (CPS). FIG. 7 is a diagram illustrating CPS 700 in accordance with various aspects of the present disclosure. The device may, for example, similar as in case of full sensing or PBPS, generate (or obtain) a resource selection trigger in a slot 702 (e.g., SL slot n). Based on a delay budget, a priority, and/or the like, of a sidelink transmission to be transmitted, and/or based on other considerations, the device may determine a set of candidate slots 704 (e.g., Y candidate slots in NR, or the like) in which it generally intends to transmit the sidelink transmission. However, in CPS, unlike as in full sensing and similar as in PBPS, the device does not perform sensing (e.g., monitoring) the channel substantially all the time prior to the slot 702. Rather, in CPS, to determine which resources in the set of candidate slots 704 are reserved by nearby devices, the device may sense (e.g., monitor) the channel for a contiguous number of slots based on control information (e.g., comprising one or more reservations, periodicities, TRA/FRA, RRI, and/or the like) indicated in sidelink transmission by other devices, for instance, as described in the context of FIG. 5. Frequency resources sensed in CPS are analogous to frequency resources sensed in full sensing described above and are defined in accordance with a resource pool (e.g., a resource pool in NR).

In one aspect of the present disclosure, in CPS, the device may perform sensing only in sensing occasions associated with reservations for retransmissions. For instance, the device may perform sensing in a contiguous partial sensing window defined by boundaries 706a and 706b. The boundaries 706a and 706b may be determined having regard to control information (e.g., SCI as described in the context of resources 502 and 510 in FIG. 5). For example, the device may consider that control information (e.g., SCI) may indicate up to a number of future reservations for retransmissions (e.g., up to 2 future reservations for retransmissions). In one aspect, the up to 2 future retransmissions may be at most 31 slots apart from the control information. In some aspects of the present disclosure, the boundary 706a of the contiguous partial sensing window may be determined such that it is located a number (e.g., 31) slots 708 before a first slot of the candidate slots 704. The boundary 706a may also be defined relative to the slot 702 and may be referred to as n+T_{A} slot 710 (with n corresponding to slot 702). In some aspects of the present disclosure, the boundary 706b of the contiguous partial sensing window may be determined such that it is shortly before a first slot of the candidate slots 704, but subject to processing constraints occurring in slots 712. The processing constraints in the slots 712 may relate to processing time for sensing result and sidelink transmission preparation time, and may, in some aspects, correspond to time offsets 610 and 612 described in the context of FIG. 6 above. The boundary 706b may also be defined relative to the slot 702 and may be referred to as n+T_{B} slot 714 (with n corresponding to slot 702).

In one or more aspects of the present disclosure, the device may be configured (e.g., pre-configured), for instance, based on a sidelink resource pool, to perform full sensing only, partial sensing (e.g., PBPS and/or CPS) only, random resource selection only, or any combination thereof. The resource pool may be, in some aspects, an SL mode 2 Tx resource pool in NR. PBPS may be for used for detecting periodic reservations (e.g., in control information such as SCI) by nearby devices. PBPS may be used based on a configuration (e.g., a higher layer parameter, for instance, by RRC signaling, such as sl-MultiReserveResource in NR) of a resource pool. CPS may be used for detecting aperiodic reservations (e.g., in control information such as SCI) of nearby devices. Partial sensing (PBPS and/or CPS) may be used based on a configuration (e.g., a higher layer parameter, for instance, by RRC signaling, such as sl-multiTBReserve in NR) of a resource pool. In some aspects, if the device intends to perform an aperiodic sidelink transmission with a single TB, the device may perform PBPS and CPS (if reserving multiple resources is enabled in a resource pool, e.g., by a higher layer parameter, for instance, by RRC signaling, such as by sl-MultiReserveResource) or CPS only (if reserving multiple resources is disabled). In addition, in some aspects, if the device determines to perform a periodic sidelink transmission with multiple TBs, the device may perform both, PBPS and CPS (if reserving multiple resources is enabled in a resource pool, e.g., by a higher layer parameter, for instance, by RRC signaling, such as by sl-MultiReserveResource). In the case in which the device performs both, PBPS and CPS, the device may combine sensing results from PBPS and CPS to determine available resources (e.g., a set of available resources S_{A} in NR to be reported to the MAC layer).

In accordance with various aspects described above, a resource selection window (e.g., the resource selection window 406 in FIG. 4) may, in full sensing, start at a time of a resource selection trigger (e.g., the resource selection trigger in the slot 402 in FIG. 4). The resource selection window may end at a time determined by the selection trigger incremented by a packet delay budget (PDB) of a TB for transmission of which the device intends to select resources. In some aspects, in full sensing, the device may have no knowledge with regard to a time (e.g., a slot) in which resource selection may be triggered. Therefore, the device may perform sensing substantially all the time as described above. In an aspect, the device may obtain knowledge about PDB at a time of obtaining the selection trigger (e.g., from a higher layer, for instance, from a MAC layer and/or from an application layer). In accordance with various aspects described above, in partial sensing (e.g., PBPS, CPS), the device may determine a set of candidate slots 604 or 704 at the resource selection trigger 602 or 702, respectively, based on PDB associated with a TB for transmission of which the device intends to select resources. In some aspects, in partial sensing, sensing occasions (for instance, the set of slots 606, the set of slots 608, or the contiguous partial sensing window defined by boundaries 706a and 706b) may be located in a time between the respective resource selection trigger 602 or 702 and the corresponding set of candidate slots 604 or 704. Expressed differently, sensing occasions and candidate slots may not overlap (i.e., may refer to disjoint slots and/or resources).

In accordance with various aspects described above, sensing methods, for instance, full sensing or partial sensing methods (e.g., PBPS, CPS) may be designed for sensing (e.g., monitoring) in a sub-6 GHz channel (e.g., in FR1 in NR). In one or more aspects of the present disclosure, sensing (e.g., monitoring) described in aforementioned methods may advantageously use a receive beam, for instance, when operating in a millimeter wave channel (e.g., in FR2 in NR). However, aspects of the present disclosure are not limited to use of millimeter waves for sensing (e.g., not limited to use of a receive beam in a millimeter wave channel).

Beamforming, which may also be referred to as spatial filtering, directional transmission, or directional reception, is a signal processing technique that may be used at a transmitting device or a receiving device (e.g., a base station 110 or a UE 120a, 120b, 120c, 120e) to shape or steer an antenna beam (e.g., a transmit beam or receive beam) along a spatial path between the transmitting device and the receiving device. An antenna beam (e.g., a transmit beam or receive beam) may also be referred to as a Transmission Configuration Indicator (TCI) state and/or spatial relation. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

FIG. 8A illustrates an exemplary process flow for creating an aperiodic mode 2 SL transmission grant according to aspects of the present disclosure. At step 810a, a UE such as the UE 120a, 120e, e.g., the MAC layer of the UE, may decide to create a mode 2 SL transmission grant for transmitting a single MAC PDU. As one skilled in the art will appreciate, the data contained in the PDU may be passed to the MAC layer from higher layers, e.g. from an application that needs to transmit the data via a SL transmission to a receiving UE. At step 820a, the UE may perform a transmission resource (re)-selection check procedure as explained in detail elsewhere herein. Step 820a may be performed to check whether transmission resource (re-)selection should be performed and to determine transmission resource selection parameters such as a resource pool for resource selection, an Li priority (e.g., prio_{Tx}), a remaining PDB, a number of subchannels (e.g., L_{subCH}), and/or the like to the PHY layer. For an aperiodic mode 2 SL transmission step 830a yields a positive result and the MAC layer may pass the determined transmission resource selection parameters to the PHY layer and may trigger a sensing-based resource (re-)selection as described elsewhere herein.

At step 840a, the UE, e.g., via a suitable PHY layer routine, may determine, as described elsewhere herein (cf. FIG. 4, 5, 6, 7, 9 or 10) in a sensing-based manner a set of available SL transmission resources (also denoted S_{A} herein) e.g., via excluding transmission resources that are reserved for other SL transmissions. The set S_{A} is then passed form the PHY layer to the MAC layer which in step 850a selects, based on the set S_{A}, a set of resources for transmission of the PDU to be transmitted. Based on the selected set of resources for transmission, in step 860a, a new mode 2 SL grant for the UE is created.

FIG. 8B illustrates an exemplary process flow for creating a periodic mode 2 SL transmission grant according to aspects of the present disclosure. At step 810b, the UE, e.g., the MAC layer of the UE, may decide to create a mode 2 SL transmission grant for transmitting multiple MAC PDUs. As one skilled in the art will appreciate, the data contained in the PDUs may be passed to the MAC layer from higher layers, e.g., from an application that needs to transmit the data via a SL transmission to a receiving UE. At step 820b the UE may perform a transmission resource (re)-selection check procedure as explained in detail elsewhere herein. Step 820b may be performed to check whether transmission resource (re-)selection should be performed and to determine transmission resource selection parameters such as a resource pool for resource selection, an Li priority (e.g., prio_{Tx}), a remaining PDB, a number of subchannels (e.g., L_{subCH}), resource reservation interval (P_{rsvp_Tx}), and/or the like to the PHY layer. For a periodic mode 2 SL transmission, step 820b may yield a negative result, e.g., when the UE determines that an already existing mode 2 SL grant will likely be sufficient for transmitting the data, and, at step 822b, the UE uses the already existing grant for transmitting the data, that may have been previously determined via a similar grant creation procedure. Step 820b may also yield a positive result, e.g., when the UE determines that no mode SL grant exists or when the UE determines that the existing grant may likely not be sufficient or not optimal for transmitting the data. In this case, at step 824b, the UE may set a value of a counter that determines for how many SL transmission periods the new SL grant is to be used by the UE for periodic SL transmissions. In some aspects, such a value for the counter may be randomly drawn from a preconfigured range or may be preconfigured by the network. At step 830b, the MAC layer may pass the determined transmission resource selection parameters to the PHY layer and may trigger sensing-based resource (re-)selection as described elsewhere herein.

At step 840b, the UE, e.g., via a suitable PHY layer routine, may determine, as described elsewhere herein (cf. FIG. 4, 5, 6, 7, 9 or 10) in a sensing-based manner a set of available SL transmission resources (also denoted S_{A} herein) e.g., via excluding transmission resources that are reserved for other SL transmissions. The set S_{A} is then passed from the PHY layer to the MAC layer which in step 850b selects, based on the set S_{A}, a set of resources for transmission of the PDU to be transmitted. Based on the selected set of resources for transmission, in step 860b, a new mode 2 SL grant for the UE is created.

FIGS. 9A and 9B are block diagrams conceptually illustrating examples of sidelink transmissions using beamforming, in accordance with various aspects of the present disclosure. A transmitting device 902 (e.g., a UE 120a, 120e, a Tx UE, or the like) may determine to use a millimeter wave channel (e.g., a channel in FR2 in NR, for instance, in a 28 GHz band) or some other channel for a sidelink transmission 904 destined for a receiving device 906 (e.g., a UE 120a, 120e, a RX UE, or the like). The transmitting device 902 may use beamforming for the sidelink transmission destined for the receiving device 906 in order to achieve favorable signal-to-noise ratio (SNR) at the receiving device 906. The transmitting device 902 may perform the beamforming by directing a signal carrying the sidelink transmission to propagate in a desired direction. In some aspects, the desired direction may be a propagation path from the transmitting device 902 to the receiving device 906 that results in a favorable (e.g., maximal) SNR at the receiving device 906. In one or more aspects of the present disclosure, the pair of devices 902 and 906 may have multiple signal propagation paths. In such cases, the device pair 902 and 906 may, depending on beamforming capability, use only a single one signal propagation path. For instance, in some aspects, the transmitting device 902 may use a transmit beam 908 and the receiving device 906 may use a receive beam 910 (shown in FIG. 9A). In other aspects, the transmitting device 902 may use a transmit beam 912 and the receiving device 906 may use a receive beam 914 (shown in FIG. 9B). The use of the transmit beam 912 and the receive beam 914 may involve a reflection of the sidelink transmission 904 on a reflector 916 (e.g., a building, or the like).

FIGS. 9C and 9D are block diagrams conceptually illustrating an example of resources available for a sidelink transmissions, in accordance with various aspects of the present disclosure. Resources available to the transmitting device 902 for a sidelink transmission destined for the receiving device 906 may depend on signal propagation path and may, for instance, be different on different propagation paths. For example, the transmitting device 902 may determine to transmit the sidelink transmission 904 using the transmit beam 912 as shown in FIG. 9C. In such a case, the transmitting device 902 may not need to consider, for instance, transmissions/reservations by another transmitting device 918 using a transmit beam 920 since the transmit beam 912 and the transmit beam 920 may not significantly interfere. In another example, the transmitting device 902 may intend to use a line-of-sight (LOS) propagation path 922 to transmit a sidelink transmission destined for the receiving device 906. In such a case, the transmitting device 902 may consider, for instance, transmissions/reservations by the transmitting device 918 in order to reduce interference (e.g., to avoid interference). The transmitting device 902 may consider the transmissions/reservations by the transmitting device 918 by performing one or more sensing methods described above. These sensing methods may comprise using a receive beam in accordance with various aspects of the present disclosure.

Referring to FIG. 9D, the transmitting device 902 may, in some aspects, determine to transmit a sidelink transmission 904 to the receiving device 906 using a LOS propagation path (e.g., using the transmit beam 908 corresponding to the receive beam 910). Another transmitting device 924 may determine to transmit its own sidelink transmissions using a transmit beam 926. The transmit beam 926 may be directed such that it is aligned with the LOS propagation path between the devices 902 and 906 as shown in FIG. 9D. A transmission from the device 924 may interfere with a reception at the device 906 of a transmission from the device 902. In such a case, the transmitting device 902 may consider, for instance, transmissions/reservations by the device 924 in order to reduce interference (e.g., to avoid interference) by performing one or more sensing methods described above. In some aspects, performing the one or more sensing methods may comprise using a receive beam 928.

FIG. 10 is a diagram illustrating an example process 1000 performed, for example, by a UE 120a, a UE 120e, or the like, in accordance with various aspects of the present disclosure. In some aspects, the process 1000 may include additional blocks, fewer blocks, different blocks, or differently arranged blocks than those depicted in FIG. 10. Additionally, or alternatively, two or more of the blocks of process 1000 may be performed in parallel.

As shown in FIG. 10, process 1000 may include determining a first set of slots within a sidelink resource pool (block 1010). In some aspects, the first set of slots may comprise (or may be equal to) a resource selection window 406, a set of candidate slots 604, or a set of candidate slots 704, as described above, and may be determined in accordance with one or more of full or partial sensing methods described above.

As further shown in FIG. 10, in some aspects, process 1000 may include determining a set of candidate single-slot resources, each candidate single-slot resource associated with a slot of the first set of slots (block 1020). In some aspects, the set of candidate single-slot resources may be defined as a set of contiguous sub-channels in a single slot of the first set of slots. In some aspects, the set of candidate single-slot resources may correspond to (or may be equal to) a set of candidate resources described above in conjunction with full and partial sensing methods.

In addition, as shown in FIG. 10, in some aspects, process 1000 may include determining a second set of slots within the sidelink resource pool based on the first set of slots, wherein the first set of slots and the second set of slots do not overlap (block 1030). In some aspects, the second set of slots may comprise (or may be equal to) a sensing window 404, or sensing occasions in accordance with a partial sending method, e.g., PBPS, such as a set of slots 606 and/or a set of slots 608, or contiguous partial sensing window as defined by boundaries 706a and 706b. The first and second set of slots used by process 1000 do not overlap (e.g., in time) and may also be referred to as being disjoint.

Moreover, as shown in FIG. 10, in some aspects, process 1000 may include monitoring for one or more transmissions comprising control information in each slot of the second set of slots, wherein the monitoring comprises using a receive beam (block 1040). In some aspects, the act of monitoring may be referred to as sensing or receiving the one or more transmissions comprising control information. In some aspects, the one or more transmissions comprising control information may comprise one or more sidelink transmissions comprising physical sidelink control channel (PSCCH). The control information may, in some aspects, comprise information indicating one or more sidelink transmissions (e.g., the control information may comprise one or more sidelink resource reservations/announcements for one or more future sidelink transmissions). The control information (e.g., indicated via PSCCH) may comprise sidelink control information (SCI) indicating one or more of time a resource assignment (TRA), a frequency resource assignment (FRA) or a resource reservation interval (RRI) as described above in the context of various sensing methods. The use of the receive beam may be based on beamforming as described above. In some aspects, the monitoring may comprise measuring reference signal received power (RSRP).

As further shown in FIG. 10, in some aspects, process 1000 may comprise selectively excluding, based on the control information, one or more resources from the set of candidate single-slot resources (block 1050). Selectively excluding a particular resource (e.g., contiguous L_{subCH} resources) from the set of candidate single-slot resources may, in some aspects, comprise determining an overlap of at least one resource (e.g., a resource block or a resource element) in one or more resources reserved by the control information and at least one resource (e.g., a resource block or a resource element) in the particular resource, followed by excluding this particular resource from the set of candidate single-slot resources based on the determined overlap. The selective excluding may be performed in accordance with one or more of full and partial sensing methods described above. In some aspects, the selective excluding may comprise selectively excluding based on the measured RSRP (e.g., based on a comparison of the measured RSPR to a threshold).

Furthermore, as shown in FIG. 10, in some aspects, process 1000 may comprise transmitting a sidelink transmission in one or more remaining resources of the set of candidate single-slot resources (block 1060). The one or more remaining resources may comprise a set S_{A} as described above in the context of various sensing methods. The transmitting may comprise, in some aspects, reporting resources, which remain in the set of candidate single-slot resources upon the selective excluding described in the context of block 1050 above, to a higher layer (e.g., to the MAC layer), followed by obtaining, from the higher layer, an indication of one or more resources to use for the transmission, and by transmitting a sidelink transmission in the indicated one or more resources.

In one or more aspects of the present disclosure, in process 1000, transmitting the sidelink transmission may comprise using a transmit beam. The receive beam used for sensing may be determined based on the transmit beam. In some aspects, the transmit beam and the receive beam may be both aligned at a propagation path (e.g., the LOS propagation path 922). Such alignment may be advantageous to reduce interference with a UE (e.g., the UE 918) located substantially within the propagation path. In some aspects, the transmit beam and the receive beam may be directed in opposite directions (e.g., the transmit beam 908, the receive beam 928). Such orientation may be advantageous to reduce interference with a UE (e.g., a UE 924) located substantially within an extension of the propagation path and transmitting along this propagation path (e.g., the transmit beam 926 of the UE 924).

In one or more of the above aspects, a width of the receive beam used for sensing and a width of the transmit beam may differ (e.g., the receive beam may be wider than the transmit beam). In some aspects, a wider receive beam may increase likelihood that transmissions and/or reservations and/or announcements by nearby devices will be sensed and considered in selection of resources for a sidelink transmission. A narrower transmit beam may, in some aspects, allow to advantageously focus energy of the sidelink transmission towards a receiving device.

In one or more aspects of the present disclosure, as an alternative or in addition to aspects described above, the sidelink transmission may be associated with a priority. For example, a sidelink transmission associated with an emergency (e.g., to report information on an accident, for instance, of a vehicle implementing one or more aspects of the present disclosure) may be associated with a higher priority than a transmission associated with a state of charge of a battery. In some aspects, a width of the receive beam used for sensing may be determined based on the priority (e.g., the width may be a monotonic function of the priority).

In some aspects, the width may be a monotonically non-decreasing function of the priority. In such a case, for example, a higher priority may generally result in a wider receive beam used for sensing. A wider receive beam may advantageously increase likelihood that a higher priority transmission is not disturbed by nearby devices since—due to a wider receive beam—transmissions and/or reservations and/or announcements by nearby devices may be sensed and own transmission on reserved resources may be avoided. In other aspects, the width of a receive beam used for sensing may be a monotonically non-increasing function of the priority. In such a case, for example, a higher priority may generally result in a narrower receive beam used for sensing. A narrower receive beam may advantageously increase likelihood that a higher priority transmission will be assigned any resource for transmission. Due to a narrower receive beam used for sensing—generally less transmissions and/or reservations and/or announcements by nearby devices may be sensed and may lead to less exclusions of candidate resources.

In one or more aspects of the present disclosure, as an alternative or in addition to the aspects described above, a width of the receive beam used for sensing may be determined based on a number of slots in the first set of slots. In some aspects, the width may be a monotonically non-decreasing function of the number of slots in the first set of slots. For example, a low number of slots in the first set of slots may advantageously be associated with a narrow receive beam. Similar as above, a narrower receive beam used for sensing may advantageously increase likelihood that own transmission will be assigned any resources. Less transmissions and/or reservations and/or announcements may be sensed and lead to exclusion of candidate resources of the first set of resources having a limited number of slots. Conversely, a high number of slots in the first set of slots may advantageously be associated with a wider receive beam. A wider receive beam used for sensing may result in more exclusions from the first set of slots due to transmissions and/or reservations and/or announcements by nearby devices which may result in less interference with own transmission. In view of a high number of slots in the first set of slots, more exclusions may not adversely affect likelihood that own transmission will be assigned any resources.

In one or more aspects of the present disclosure, as an alternative or in addition to the aspects described above, slots in the second set of slots may be determined in accordance with PBPS and/or in accordance with CPS. The receive beam used in the monitoring for one or more transmissions may be a first receive beam in slots determined in accordance with PBPS, and a second receive beam in slots determined in accordance with CPS. For example, the first receive beam and the second receive beam may be different. In some aspects, the second receive beam (for CPS-determined slots) may be wider than the first receive beam (for PBPS-determined slots), for instance, since sensing duration may be short, for example, in some aspects, the number of slots sensed for CPS may be less than the number of slots sensed for PBPS, if k≥2.

In one or more aspects of the present disclosure, as an alternative or in addition to the aspects described above, using the receive beam for sensing may comprise obtaining an indication of a receive beam to be used for sensing from a MAC layer. The indication may be obtained, for example, at a PHY layer. The PHY layer may determine a receive beam to be used in sensing based on the indication. In some aspects, the PHY layer may determine to use a receive beam as indicated by the MAC layer. In other aspects, the PHY layer may determine to use a modified (or altered) receive beam relative to a receive beam indicated by the MAC layer, for example, based on information which is available at the PHY layer but is not available at the MAC layer. In one additional aspect, an indication of a relationship between the indicated receive beam and the determined receive beam may be provided to the MAC layer. Such indication may be provided in conjunction with reporting to the MAC layer remaining resources in the set of candidate resources (e.g., a set of available resources S_{A} in NR) by the PHY layer.

In one or more aspects of the present disclosure, as an alternative or in addition to the aspects described above, the receive beam used for sensing may be dynamically determined by a UE. For example, at least one of a direction of the receive beam and/or a width of the receive beam may be dynamically determined by the UE. In some aspects, the act of dynamically determining may refer, for example, to periodically determining, or determining based on a trigger (e.g., based on an internal trigger, upon a trigger received from a base station or other UE, or the like).

In one or more aspects of the present disclosure, as an alternative or in addition to the aspects described above, the UE may be configured to operate at least in part in accordance with one or more Technical Specifications (TS) produced by a third Generation Partnership Project (3GPP).

In the following, several aspects of the present disclosure are presented:
Aspect 1. A method for wireless communication, the method performed by a user equipment (UE), the method comprising:
determining a first set of slots within a sidelink resource pool;
determining a set of candidate single-slot resources, each candidate single-slot resource associated with a slot of the first set of slots;
determining a second set of slots within the sidelink resource pool based on the first set of slots, wherein the first set of slots and the second set of slots do not overlap;
monitoring for one or more transmissions comprising control information in each slot of the second set of slots, wherein the monitoring comprises using a receive beam;
selectively excluding, based on the control information, one or more resources from the set of candidate single-slot resources; and
transmitting a sidelink transmission in one or more remaining resources of the set of candidate single-slot resources.

Aspect 2. The method of aspect 1, wherein the transmitting the sidelink transmission comprises using a transmit beam, and wherein the receive beam is determined based on the transmit beam.
Aspect 3. The method of any one of aspects 1 to 2, wherein a direction of the receive beam and a direction of the transmit beam are substantially equal.
Aspect 4. The method of any one of aspects 1 to 3, wherein a direction of the receive beam and a direction of the transmit beam are substantially opposite.
Aspect 5. The method of any one of aspects 1 to 4, wherein a width of the receive beam and a width of the transmit beam are different.
Aspect 6. The method of any one of aspects 1 to 5, wherein the sidelink transmission is associated with a priority, and wherein a width of the receive beam is determined based on the priority.
Aspect 7. The method of any one of aspects 1 to 6, wherein the width is a monotonic function of the priority.
Aspect 8. The method of any one of aspects 1 to 7, wherein the width is a monotonically non-decreasing function of the priority.
Aspect 9. The method of any one of aspects 1 to 8, wherein the width is a monotonically non-increasing function of the priority.
Aspect 10. The method of any one of aspects 1 to 9, wherein a width of the receive beam is determined based on a number of slots in the first set of slots.
Aspect 11. The method of any one of aspects 1 to 10, wherein the width is a monotonically non-decreasing function of the number of slots in the first set of slots.
Aspect 12. The method of any one of aspects 1 to 11, wherein slots in the second set of slots are determined in accordance with periodic-based partial sensing (PBPS) and/or in accordance with contiguous partial sensing (CPS), and wherein the using the receive beam comprises using a first receive beam in one or more slots of the second set of slots determined in accordance with PBPS and using a second receive beam in one or more slots of the second set of slots determined in accordance with CPS.
Aspect 13. The method of any one of aspects 1 to 12, wherein the first receive beam and the second receive beam are different.
Aspect 14. The method of any one of aspects 1 to 13, wherein using the receive beam comprises:
obtaining an indication of a receive beam from a media access control (MAC) layer; and determining a receive beam to be used based on the indication.
Aspect 15. The method of any one of aspects 1 to 14, further comprising:
providing, to the MAC layer, an indication of a relationship between the obtained indication of a receive beam and the determined receive beam.
Aspect 16. The method of any one of aspects 1 to 15, wherein the receive beam is dynamically determined by the UE.
Aspect 17. The method of any one of aspects 1 to 16, wherein at least one of a direction of the receive beam is dynamically determined by the UE or a width of the receive beam is dynamically determined by the UE.
Aspect 18. The method of any one of aspects 1 to 17, wherein the one or more transmissions comprising the control information comprise one or more sidelink transmissions comprising physical sidelink control channel (PSCCH), and wherein the control information comprises sidelink control information (SCI) indicating one or more of a time resource assignment (TRA), a frequency resource assignment (FRA) or a resource reservation interval (RRI).
Aspect 19. The method of any one of aspects 1 to 18, wherein the monitoring comprises measuring reference signal received power (RSRP), and wherein the selective excluding comprises selectively excluding based on the measured RSRP.
Aspect 20. An apparatus for wireless communication, the apparatus comprising:
means for determining a first set of slots within a sidelink resource pool;
means for determining a set of candidate single-slot resources, each candidate single-slot resource associated with a slot of the first set of slots;
means for determining a second set of slots within the sidelink resource pool based on the first set of slots, wherein the first set of slots and the second set of slots do not overlap;
means for monitoring for one or more transmissions comprising control information in each slot of the second set of slots, wherein the monitoring comprises using a receive beam;
means for selectively excluding, based on the control information, one or more resources from the set of candidate single-slot resources; and
means for transmitting a sidelink transmission in one or more remaining resources of the set of candidate single-slot resources.
Aspect 21. An apparatus for wireless communication, the apparatus comprising:
a memory; and
one or more processors coupled to the memory, the memory and the one or more processors being configured to:
determine a first set of slots within a sidelink resource pool;
determine a set of candidate single-slot resources, each candidate single-slot resource associated with a slot of the first set of slots;
determine a second set of slots within the sidelink resource pool based on the first set of slots, wherein the first set of slots and the second set of slots do not overlap;
monitor for one or more transmissions comprising control information in each slot of the second set of slots, wherein the monitoring comprises using a receive beam;
selectively exclude, based on the control information, one or more resources from the set of candidate single-slot resources; and
transmit a sidelink transmission in one or more remaining resources of the set of candidate single-slot resources.
Aspect 22. The apparatus of aspect 21, wherein the memory and the one or more processors, when transmitting the sidelink transmission, are further configured to use a transmit beam, and wherein the receive beam is determined based on the transmit beam.
Aspect 23. The apparatus of any one of aspects 21 to 22, wherein the sidelink transmission is associated with a priority, and wherein a width of the receive beam is determined based on the priority.
Aspect 24. The apparatus of any one of aspects 21 to 23, wherein a width of the receive beam is determined based on a number of slots in the first set of slots.
Aspect 25. The apparatus of any one of aspects 21 to 24, wherein slots in the second set of slots are determined in accordance with periodic-based partial sensing (PBPS) and/or in accordance with contiguous partial sensing (CPS), and wherein the using the receive beam comprises using a first receive beam in one or more slots of the second set of slots determined in accordance with PBPS and using a second receive beam in one or more slots of the second set of slots determined in accordance with CPS.
Aspect 26. A non-transitory computer-readable medium storing one or more instructions for wireless communication, the one or more instructions, when executed by one or more processors, cause the one or more processors to:
determine a first set of slots within a sidelink resource pool;
determine a set of candidate single-slot resources, each candidate single-slot resource associated with a slot of the first set of slots;
determine a second set of slots within the sidelink resource pool based on the first set of slots, wherein the first set of slots and the second set of slots do not overlap;
monitor for one or more transmissions comprising control information in each slot of the second set of slots, wherein the monitoring comprises using a receive beam;
selectively exclude, based on the control information, one or more resources from the set of candidate single-slot resources; and
transmit a sidelink transmission in one or more remaining resources of the set of candidate single-slot resources.
Aspect 27. The non-transitory computer-readable medium of aspect 26, wherein the one or more instructions, when causing the one or more processors to transmit the sidelink transmission, further cause the one or more processors to use a transmit beam, and wherein the receive beam is determined based on the transmit beam.
Aspect 28. The non-transitory computer-readable medium of any one of aspects 26 to 27, wherein the sidelink transmission is associated with a priority, and wherein a width of the receive beam is determined based on the priority.
Aspect 29. The non-transitory computer-readable medium of any one of aspects 26 to 28, wherein a width of the receive beam is determined based on a number of slots in the first set of slots.
Aspect 30. The non-transitory computer-readable medium of any one of aspects 26 to 29, wherein slots in the second set of slots are determined in accordance with periodic-based partial sensing (PBPS) and/or in accordance with contiguous partial sensing (CPS), and wherein the using the receive beam comprises using a first receive beam in one or more slots of the second set of slots determined in accordance with PBPS and using a second receive beam in one or more slots of the second set of slots determined in accordance with CPS.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

It will be apparent that systems and/or methods described herein may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various aspects. In fact, many of these features may be combined in ways not specifically recited in the claims and/or dis-closed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchange-ably with “one or more.” Where only one item is intended, the phrase “only one” or similar language is used. Also, as used herein, the terms “has,” “have,” “having,” and/or the like are intended to be open-ended terms.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

1. A method for wireless communication, the method performed by a user equipment (UE), the method comprising:
determining a first set of slots within a sidelink resource pool;
determining a set of candidate single-slot resources, each candidate single-slot resource associated with a slot of the first set of slots;
determining a second set of slots within the sidelink resource pool based on the first set of slots, wherein the first set of slots and the second set of slots do not overlap;
monitoring for one or more transmissions comprising control information in each slot of the second set of slots, wherein the monitoring comprises using a receive beam;
selectively excluding, based on the control information, one or more resources from the set of candidate single-slot resources; and
transmitting a sidelink transmission in one or more remaining resources of the set of candidate single-slot resources.

2. The method of claim 1, wherein transmitting the sidelink transmission comprises using a transmit beam, and wherein the receive beam is determined based on the transmit beam.

3. The method of claim 2, wherein a direction of the receive beam and a direction of the transmit beam are substantially equal.

4. The method of claim 2, wherein a direction of the receive beam and a direction of the transmit beam are substantially opposite.

5. The method of claim 2, wherein a width of the receive beam and a width of the transmit beam are different.

6. The method of claim 1, wherein the sidelink transmission is associated with a priority, and wherein a width of the receive beam is determined based on the priority.

7. The method of claim 6, wherein the width is a monotonic function of the priority.

8. The method of claim 7, wherein the width is a monotonically non-decreasing function of the priority.

9. The method of claim 7, wherein the width is a monotonically non-increasing function of the priority.

10. The method of claim 1, wherein a width of the receive beam is determined based on a number of slots in the first set of slots.

11. The method of claim 10, wherein the width is a monotonically non-decreasing function of the number of slots in the first set of slots.

12. The method of claim 1, wherein slots in the second set of slots are determined in accordance with periodic-based partial sensing (PBPS) and/or in accordance with contiguous partial sensing (CPS), and wherein the using the receive beam comprises using a first receive beam in one or more slots of the second set of slots determined in accordance with PBPS and using a second receive beam in one or more slots of the second set of slots determined in accordance with CPS.

13. The method of claim 12, wherein the first receive beam and the second receive beam are different.

14. The method of claim 1, wherein using the receive beam comprises:
obtaining an indication of a receive beam from a media access control (MAC) layer; and
determining a receive beam to be used based on the indication.

15. The method of claim 14, further comprising:
providing, to the MAC layer, an indication of a relationship between the obtained indication of a receive beam and the determined receive beam.

16. The method of claim 1, wherein the receive beam is dynamically determined by the UE.

17. The method of claim 16, wherein at least one of a direction of the receive beam is dynamically determined by the UE or a width of the receive beam is dynamically determined by the UE.

18. The method of claim 1, wherein the one or more transmissions comprising the control information comprise one or more sidelink transmissions comprising physical sidelink control channel (PSCCH), and wherein the control information comprises sidelink control information (SCI) indicating one or more of a time resource assignment (TRA), a frequency resource assignment (FRA) or a resource reservation interval (RRI).

19. The method of claim 1, wherein the monitoring comprises measuring reference signal received power (RSRP), and wherein the selective excluding comprises selectively excluding based on the measured RSRP.

20. An apparatus for wireless communication, the apparatus comprising:
means for determining a first set of slots within a sidelink resource pool;
means for determining a set of candidate single-slot resources, each candidate single-slot resource associated with a slot of the first set of slots;
means for determining a second set of slots within the sidelink resource pool based on the first set of slots, wherein the first set of slots and the second set of slots do not overlap;
means for monitoring for one or more transmissions comprising control information in each slot of the second set of slots, wherein the monitoring comprises using a receive beam;
means for selectively excluding, based on the control information, one or more resources from the set of candidate single-slot resources; and
means for transmitting a sidelink transmission in one or more remaining resources of the set of candidate single-slot resources.

21. An apparatus for wireless communication, the apparatus comprising:
a memory; and
one or more processors coupled to the memory, the memory and the one or more processors being configured to:
determine a first set of slots within a sidelink resource pool;
determine a set of candidate single-slot resources, each candidate single-slot resource associated with a slot of the first set of slots;
determine a second set of slots within the sidelink resource pool based on the first set of slots, wherein the first set of slots and the second set of slots do not overlap;
monitor for one or more transmissions comprising control information in each slot of the second set of slots, wherein the monitoring comprises using a receive beam;
selectively exclude, based on the control information, one or more resources from the set of candidate single-slot resources; and
transmit a sidelink transmission in one or more remaining resources of the set of candidate single-slot resources.

22. The apparatus of claim 21, wherein the memory and the one or more processors, when transmitting the sidelink transmission, are further configured to use a transmit beam, and wherein the receive beam is determined based on the transmit beam.

23. The apparatus of claim 21, wherein the sidelink transmission is associated with a priority, and wherein a width of the receive beam is determined based on the priority.

24. The apparatus of claim 21, wherein a width of the receive beam is determined based on a number of slots in the first set of slots.

25. The apparatus of claim 21, wherein slots in the second set of slots are determined in accordance with periodic-based partial sensing (PBPS) and/or in accordance with contiguous partial sensing (CPS), and wherein the using the receive beam comprises using a first receive beam in one or more slots of the second set of slots determined in accordance with PBPS and using a second receive beam in one or more slots of the second set of slots determined in accordance with CPS.

26. A non-transitory computer-readable medium storing one or more instructions for wireless communication, the one or more instructions, when executed by one or more processors, cause the one or more processors to:
determine a first set of slots within a sidelink resource pool;
determine a set of candidate single-slot resources, each candidate single-slot resource associated with a slot of the first set of slots;
determine a second set of slots within the sidelink resource pool based on the first set of slots, wherein the first set of slots and the second set of slots do not overlap;
monitor for one or more transmissions comprising control information in each slot of the second set of slots, wherein the monitoring comprises using a receive beam;
selectively exclude, based on the control information, one or more resources from the set of candidate single-slot resources; and
transmit a sidelink transmission in one or more remaining resources of the set of candidate single-slot resources.

27. The non-transitory computer-readable medium of claim 26, wherein the one or more instructions, when causing the one or more processors to transmit the sidelink transmission, further cause the one or more processors to use a transmit beam, and wherein the receive beam is determined based on the transmit beam.

28. The non-transitory computer-readable medium of claim 26, wherein the sidelink transmission is associated with a priority, and wherein a width of the receive beam is determined based on the priority.

29. The non-transitory computer-readable medium of claim 26, wherein a width of the receive beam is determined based on a number of slots in the first set of slots.

30. The non-transitory computer-readable medium of claim 26, wherein slots in the second set of slots are determined in accordance with periodic-based partial sensing (PBPS) and/or in accordance with contiguous partial sensing (CPS), and wherein the using the receive beam comprises using a first receive beam in one or more slots of the second set of slots determined in accordance with PBPS and using a second receive beam in one or more slots of the second set of slots determined in accordance with CPS.
